(19) United States
(12) Patent Application Publication
(10) Pub. No.: US 2024/0284270 A1
(43) Pub. Date: Aug. 22, 2024

(54) REPORT CONFIGURATION FOR SERVING CELL AND CANDIDATE CELL

(71) Applicant: QUALCOMM Incorporated, San Diego, CA (US)

(72) Inventors: Naeem AKL, Bridgewater, NJ (US); Jelena DAMNJANOVIC, Del Mar, CA (US)

(21) Appl. No.: 18/440,138

(22) Filed: Feb. 13, 2024

Related U.S. Application Data
(60) Provisional application No. 63/485,484, filed on Feb. 16, 2023.

(51) Int. Cl. H04W 36/00; H04B 7/06; H04W 36/04

(52) U.S. Cl. CPC H04W 36/0058; H04B 7/0626; H04W 36/04

(57) ABSTRACT

Various aspects of the present disclosure generally relate to wireless communication. In some aspects, a user equipment (UE) may receive, from a serving cell, an updated serving cell configuration that includes a report configuration associated with reporting measurements for a layer 1 or layer 2 triggered mobility (LTM) candidate cell. The UE may transmit, to the serving cell via a lower layer transmission, a measurement report that is based at least in part on the report configuration and that includes a measurement for the LTM candidate cell. Numerous other aspects are described.

### CROSS-REFERENCE TO RELATED APPLICATION

This patent application claims priority to U.S. Provisional Patent Application No. 63/485,484, filed on Feb. 16, 2023, entitled “REPORT CONFIGURATION FOR SERVING CELL AND CANDIDATE CELL,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for a report configuration for a serving cell and a candidate cell.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving, from a serving cell, an updated serving cell configuration that includes a report configuration associated with reporting measurements for a layer 1 or layer 2 triggered mobility (LTM) candidate cell. The method may include transmitting, to the serving cell via a lower layer transmission, a measurement report that is based at least in part on the report configuration and that includes a measurement for the LTM candidate cell.

Some aspects described herein relate to a method of wireless communication performed by a serving cell. The method may include transmitting, to a UE, an updated serving cell configuration that includes a report configuration associated with reporting measurements for an LTM candidate cell. The method may include receiving, from the UE via a lower layer transmission, a measurement report that is based at least in part on the report configuration and that includes a measurement for the LTM candidate cell.

Some aspects described herein relate to an apparatus for wireless communication at a UE. The apparatus may include a memory and one or more processors coupled to the memory. The one or more processors may be configured to receive, from a serving cell, an updated serving cell configuration that includes a report configuration associated with reporting measurements for an LTM candidate cell. The one or more processors may be configured to transmit, to the serving cell via a lower layer transmission, a measurement report that is based at least in part on the report configuration and that includes a measurement for the LTM candidate cell.

Some aspects described herein relate to an apparatus for wireless communication at a serving cell. The apparatus may include a memory and one or more processors coupled to the memory. The one or more processors may be configured to transmit, to a UE, an updated serving cell configuration that includes a report configuration associated with reporting measurements for an LTM candidate cell. The one or more processors may be configured to receive, from the UE via a lower layer transmission, a measurement report that is based at least in part on the report configuration and that includes a measurement for the LTM candidate cell.

Some aspects described herein relate to a non-transitory computer-readable medium that stores a set of instructions for wireless communication by a UE. The set of instructions, when executed by one or more processors of the UE, may cause the UE to receive, from a serving cell, an updated serving cell configuration that includes a report configuration associated with reporting measurements for an LTM candidate cell. The set of instructions, when executed by one or more processors of the UE, may cause the UE to transmit, to the serving cell via a lower layer transmission, a measurement report that is based at least in part on the report configuration and that includes a measurement for the LTM candidate cell.

Some aspects described herein relate to a non-transitory computer-readable medium that stores a set of instructions for wireless communication by a serving cell. The set of instructions, when executed by one or more processors of the serving cell, may cause the serving cell to transmit, to a UE, an updated serving cell configuration that includes a report configuration associated with reporting measurements for an LTM candidate cell. The set of instructions, when executed by one or more processors of the serving cell, may cause the serving cell to receive, from the UE via a lower layer transmission, a measurement report that is based at least in part on the report configuration and that includes a measurement for the LTM candidate cell.

Some aspects described herein relate to an apparatus for wireless communication. The apparatus may include means for receiving, from a serving cell, an updated serving cell configuration that includes a report configuration associated with reporting measurements for an LTM candidate cell. The apparatus may include means for transmitting, to the serving cell via a lower layer transmission, a measurement report that is based at least in part on the report configuration and that includes a measurement for the LTM candidate cell.

Some aspects described herein relate to an apparatus for wireless communication. The apparatus may include means for transmitting, to a UE, an updated serving cell configuration that includes a report configuration associated with reporting measurements for an LTM candidate cell. The apparatus may include means for receiving, from the UE via a lower layer transmission, a measurement report that is based at least in part on the report configuration and that includes a measurement for the LTM candidate cell.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of physical channels and reference signals in a wireless network, in accordance with the present disclosure.

FIG. 5 is a diagram illustrating an example of layer 1 or layer 2 triggered mobility, in accordance with the present disclosure.

FIG. 6 is a diagram illustrating an example of measurement reporting, in accordance with the present disclosure.

FIG. 7 is a diagram illustrating an example of a report configuration for a serving cell and a candidate cell, in accordance with the present disclosure.

FIG. 8 is a diagram illustrating an example process performed, for example, by a UE, in accordance with the present disclosure.

FIG. 9 is a diagram illustrating an example process performed, for example, by a serving cell, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

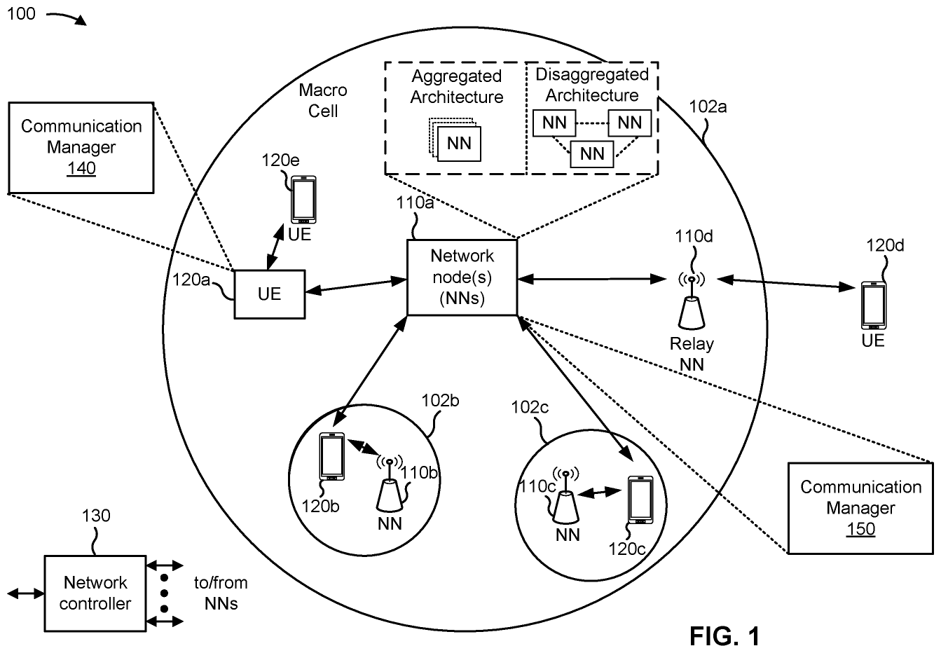

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120c), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive, from a serving cell, an updated serving cell configuration that includes a report configuration associated with reporting measurements for a layer 1 or layer 2 triggered mobility (LTM) candidate cell; and transmit, to the serving cell via a lower layer transmission, a measurement report that is based at least in part on the report configuration and that includes a measurement for the LTM candidate cell. Additionally, or alternatively, the communication manager 140 may perform one or more other operations described herein.

In some aspects, a serving cell (e.g., associated with the network node 110) may include a communication manager 150. As described in more detail elsewhere herein, the communication manager 150 may transmit, to a UE, an updated serving cell configuration that includes a report configuration associated with reporting measurements for an LTM candidate cell; and receive, from the UE via a lower layer transmission, a measurement report that is based at least in part on the report configuration and that includes a measurement for the LTM candidate cell. Additionally, or alternatively, the communication manager 150 may perform one or more other operations described herein.

As indicated above, FIG. 1 is provided as an example. Other examples may differ from what is described with regard to FIG. 1.

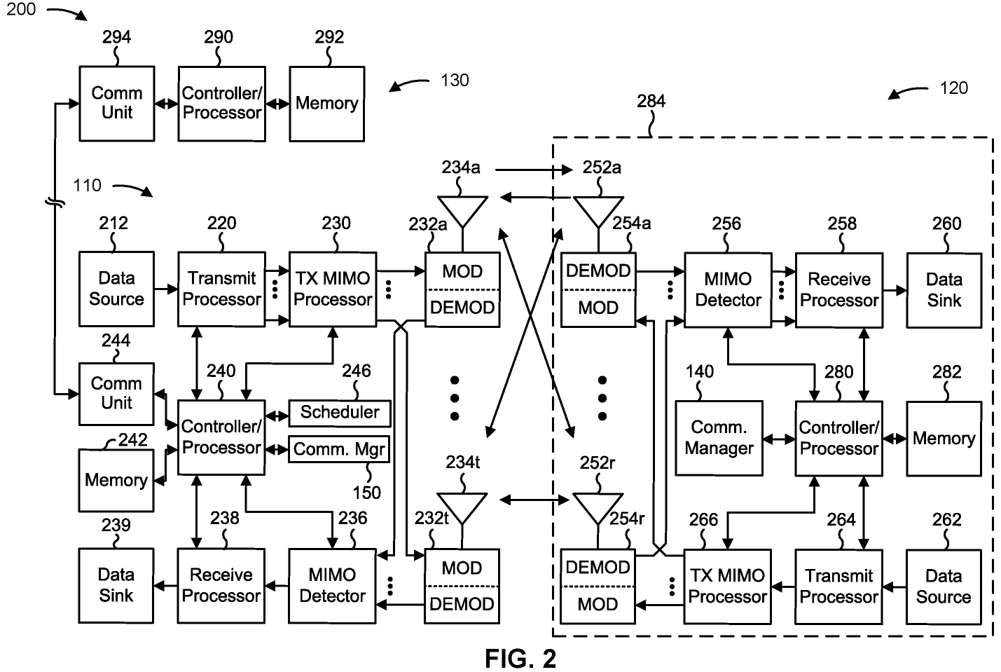

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

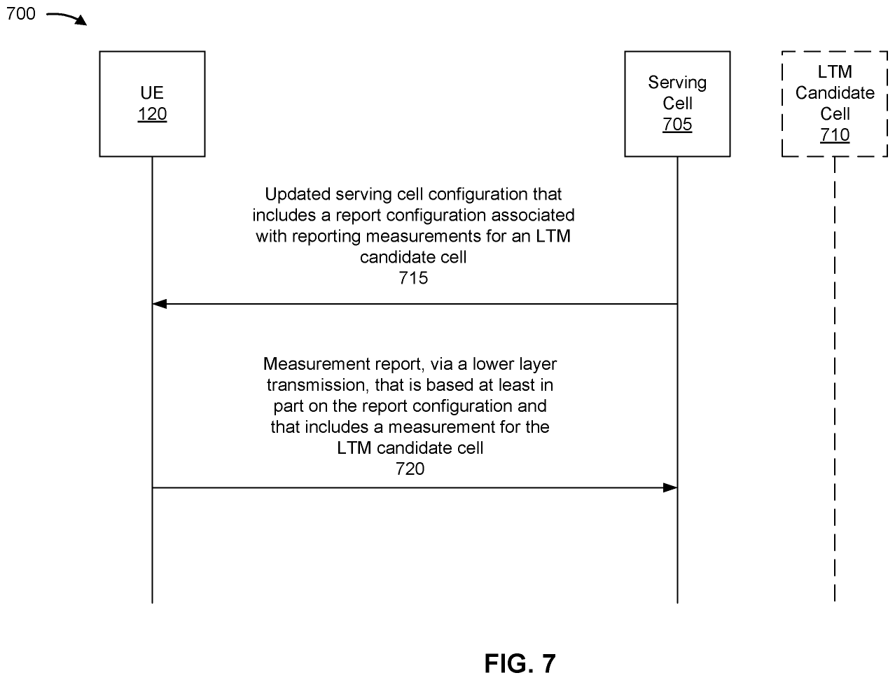

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-11).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-11).

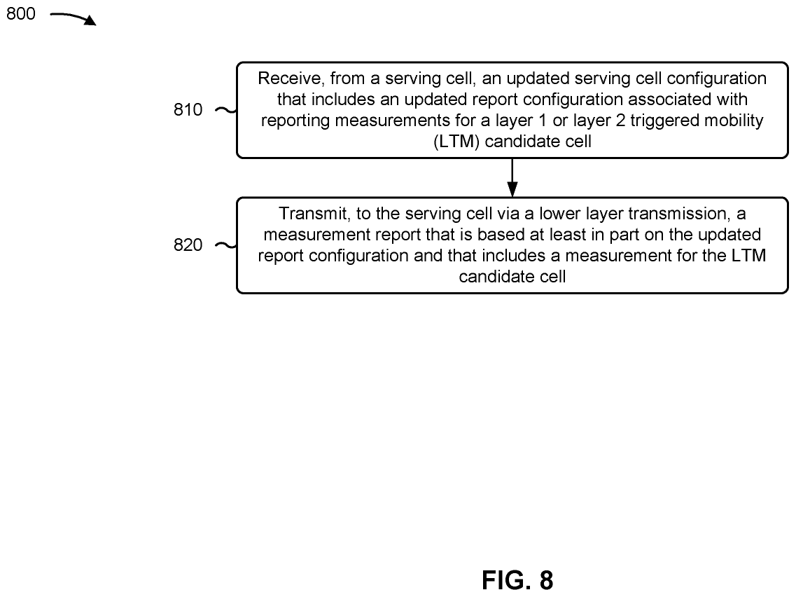

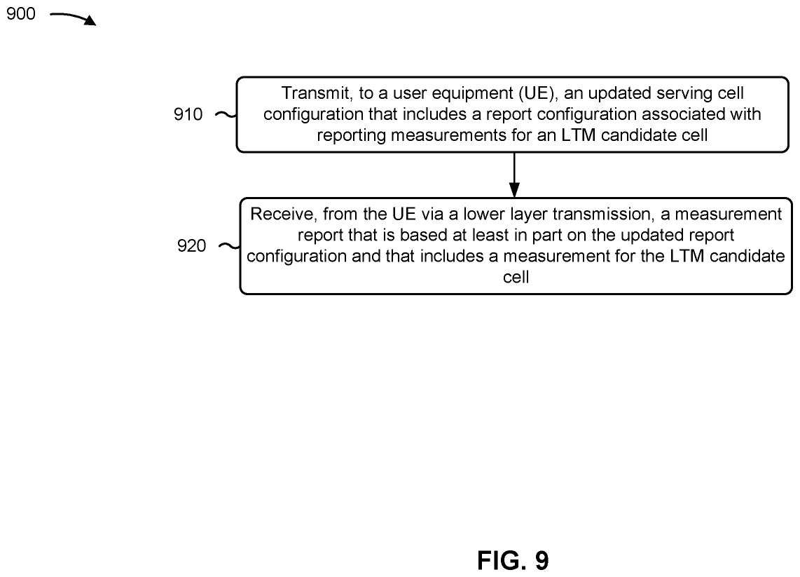

The controller/processor 240 of the network node 110, the controller/processor 280 of the UE 120, and/or any other component(s) of FIG. 2 may perform one or more techniques associated with a report configuration for a serving cell and a candidate cell, as described in more detail elsewhere herein. For example, the controller/processor 240 of the network node 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, a UE includes means for receiving (e.g., using antenna 252, modem 254, MIMO detector 256, receive processor 258, controller/processor 280, memory 282, or the like), from a serving cell, an updated serving cell configuration that includes a report configuration associated with reporting measurements for an LTM candidate cell; and/or means for transmitting (e.g., using controller/processor 280, transmit processor 264, TX MIMO processor 266, modem 254, antenna 252, memory 282, or the like), to the serving cell via a lower layer transmission, a measurement report that is based at least in part on the report configuration and that includes a measurement for the LTM candidate cell. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a serving cell includes means for transmitting (e.g., using controller/processor 240, transmit processor 220, TX MIMO processor 230, modem 232, antenna 234, memory 242, or the like), to a UE, an updated serving cell configuration that includes a report configuration associated with reporting measurements for an LTM candidate cell; and/or means for receiving (e.g., using antenna 234, modem 232, MIMO detector 236, receive processor 238, controller/processor 240, memory 242, or the like), from the UE via a lower layer transmission, a measurement report that is based at least in part on the report configuration and that includes a measurement for the LTM candidate cell. In some aspects, the means for the serving cell to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (CNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and No errors found. RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

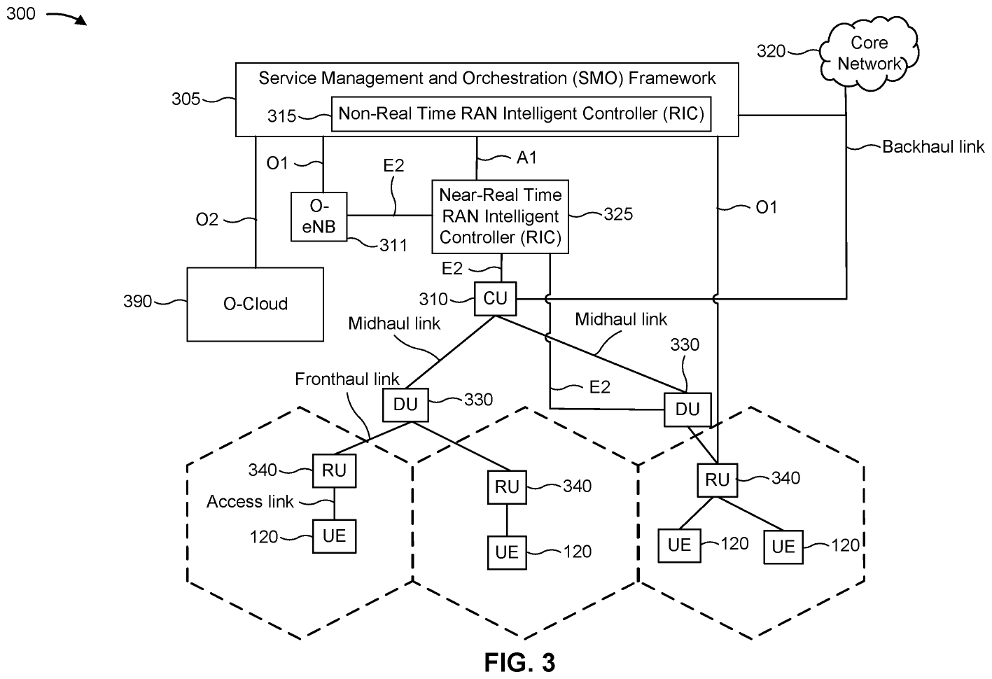

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (IFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-cNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

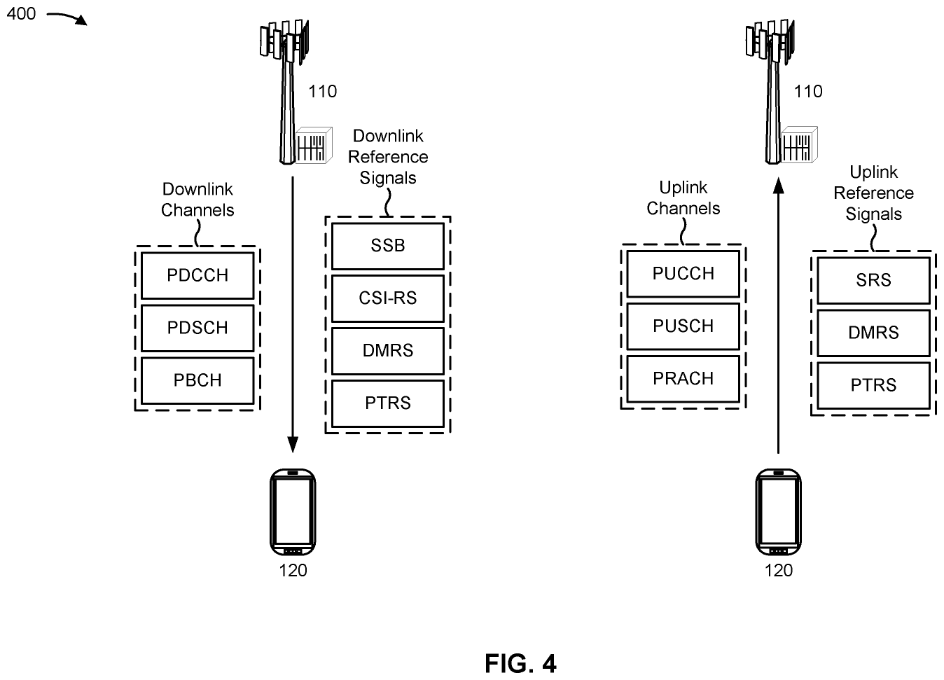

FIG. 4 is a diagram illustrating an example 400 of physical channels and reference signals in a wireless network, in accordance with the present disclosure. As shown in FIG. 4, downlink channels and downlink reference signals may carry information from a network node 110 to a UE 120, and uplink channels and uplink reference signals may carry information from a UE 120 to a network node 110.

As shown, a downlink channel may include a physical downlink control channel (PDCCH) that carries downlink control information (DCI), a physical downlink shared channel (PDSCH) that carries downlink data, or a physical broadcast channel (PBCH) that carries system information, among other examples. In some aspects, PDSCH communications may be scheduled by PDCCH communications. As further shown, an uplink channel may include a physical uplink control channel (PUCCH) that carries uplink control information (UCI), a physical uplink shared channel (PUSCH) that carries uplink data, or a physical random access channel (PRACH) used for initial network access, among other examples. In some aspects, the UE 120 may transmit acknowledgement (ACK) or negative acknowledgement (NACK) feedback (e.g., ACK/NACK feedback or ACK/NACK information) in UCI on the PUCCH and/or the PUSCH.

As further shown, a downlink reference signal may include a synchronization signal block (SSB), a channel state information (CSI) reference signal (CSI-RS), a demodulation reference signal (DMRS), a positioning reference signal (PRS), or a phase tracking reference signal (PTRS), among other examples. As also shown, an uplink reference signal may include a sounding reference signal (SRS), a DMRS, or a PTRS, among other examples.

An SSB may carry information used for initial network acquisition and synchronization, such as a primary synchronization signal (PSS), a secondary synchronization signal (SSS), a PBCH, and a PBCH DMRS. An SSB is sometimes referred to as a synchronization signal/PBCH (SS/PBCH) block. In some aspects, the network node 110 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The network node 110 may configure a set of CSI-RSs for the UE 120, and the UE 120 may measure the configured set of CSI-RSs. Based at least in part on the measurements, the UE 120 may perform channel estimation and may report channel estimation parameters to the network node 110 (e.g., in a CSI report), such as a channel quality indicator (CQI), a precoding matrix indicator (PMI), a CSI-RS resource indicator (CRI), a layer indicator (LI), a rank indicator (RI), or a reference signal received power (RSRP), among other examples. The network node 110 may use the CSI report to select transmission parameters for downlink communications to the UE 120, such as a number of transmission layers (e.g., a rank), a precoding matrix (e.g., a precoder), a modulation and coding scheme (MCS), or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (e.g., on the PDSCH) and uplink communications (e.g., on the PUSCH).

A PRS may carry information used to enable timing or ranging measurements of the UE 120 based on signals transmitted by the network node 110 to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring network nodes in order to perform OTDOA-based positioning. Accordingly, the UE 120 may receive a PRS from multiple cells (e.g., a reference cell and one or more neighbor cells), and may report a reference signal time difference (RSTD) based on OTDOA measurements associated with the PRSs received from the multiple cells. In some aspects, the network node 110 may then calculate a position of the UE 120 based on the RSTD measurements reported by the UE 120.

An SRS may carry information used for uplink channel estimation, which may be used for scheduling, link adaptation, precoder selection, or beam management, among other examples. The network node 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The network node 110 may measure the SRSs, may perform channel estimation based at least in part on the measurements, and may use the SRS measurements to configure communications with the UE 120.

As indicated above, FIG. 4 is provided as an example. Other examples may differ from what is described with regard to FIG. 4.

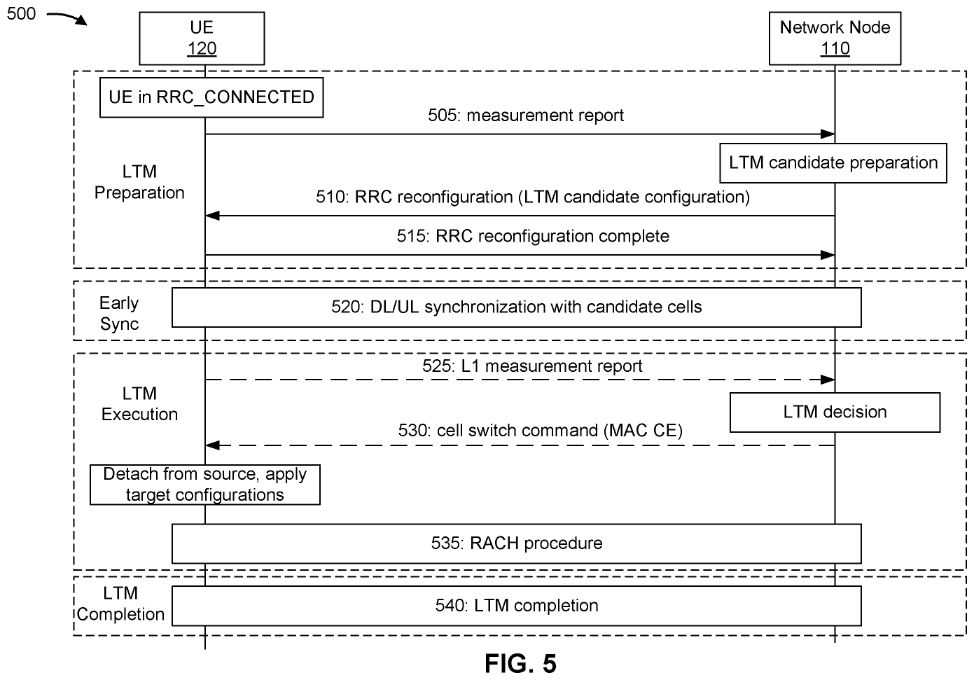

FIG. 5 is a diagram illustrating an example 500 of layer 1 (L1) or layer 2 (L2) triggered mobility (LTM), in accordance with the present disclosure. A UE 120 may communicate with a network node 110. In some cases, the network node 110 may be a base station such as a gNB.

As shown by reference number 505, the UE 120 sends a MeasurementReport message to the network node 110. The MeasurementReport message according to a previous serving cell configuration and report configuration. Hence, it is understood that prior to reference number 505, the network node 110 transmitted the previous serving cell configuration and previous report configuration. Responsive to the MeasurementReport message, the network node 110 decides to use LTM and initiates LTM candidate preparation.

As shown by reference number 510, the network node 110 transmits an RRCReconfiguration message to the UE 120 including the configuration of one or more LTM candidate target cells.

As shown by reference number 515, the UE 120 stores the configuration of LTM candidate target cell(s) and transmits an RRCReconfigurationComplete message to the network node 110.

As shown by reference number 520, the UE 120 may perform downlink (DL) synchronization and timing advance (TA) acquisition with candidate target cell(s) before receiving the LTM cell switch command.

As shown by reference number 525, the UE 120 performs L1 measurements on the configured LTM candidate target cell(s) and transmits lower-layer measurement reports to the network node 110.

As shown by reference number 530, the network node 110 determines to execute an LTM cell switch to a target cell and transmits a MAC control element (MAC-CE) triggering the LTM cell switch by including the candidate configuration index of the target cell. The UE 120 switches to the configuration of the LTM candidate target cell.

As shown by reference number 535, the UE 120 performs a random access procedure toward the target cell, if TA is not available.

As shown by reference number 540, the UE 120 indicates successful completion of the LTM cell switch toward the target cell.

In some cases, RAN2 (e.g., RAN2 #119bis-e agreement) indicates that sequential L1/L2 cell changes between candidates without RRC reconfiguration can be supported. However, for a single RRC configuration, serving cells and candidate cells may change after every LTM execution.

As indicated above, FIG. 5 is provided as an example. Other examples may differ from what is described with regard to FIG. 5.

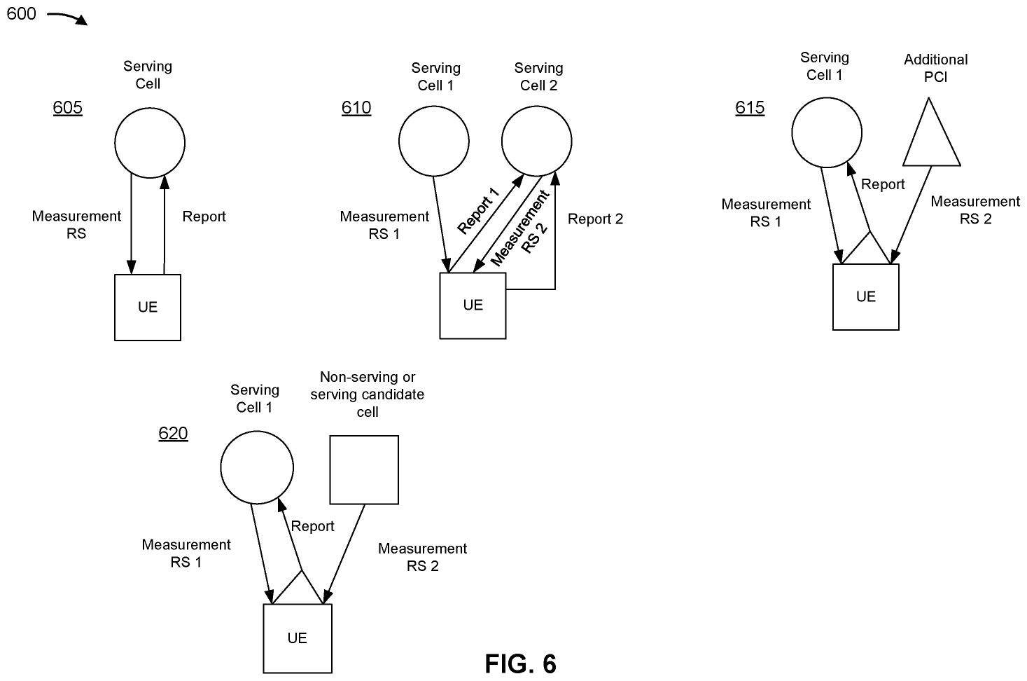

FIG. 6 is a diagram illustrating an example 600 of measurement reporting, in accordance with the present disclosure.

As shown by reference number 605, the UE measures a serving cell and submits report on the same serving cell. The CSI resource configuration and CSI report configuration are part of the serving cell configuration of the serving cell.

As shown by reference number 610, the UE measures serving cell 1 and submits a report onto serving cell 2. This may apply, for example, to carrier aggregation. The CSI resource configuration of cell 1 is part of the serving cell configuration of serving cell 1. The CSI report configuration of cell 1 is part of the serving cell configuration of serving cell 2. The reporting of cell 1 and cell 2 onto cell 2 may be separate.

As shown by reference number 615, the UE measures a cell associated with an additional physical cell identity (PCI) and submits a report onto the serving cell. This may apply, for example, to mTRP. The CSI resource configuration of the additional PCI is part of the SSB measurement timing configuration (SMTC) in MeasObjectNR. The CSI resource configuration of the serving cell includes a pointer to the SMTC of the additional PCI. The CSI report configuration of the serving cell includes a pointer to the CSI resource configuration of the serving cell. The reporting of the serving cell PCI and additional PCIs may be combined.

As shown by reference number 620, the UE performs L1 measurements of an LTM candidate cell and reports the measurements to a serving cell. This may apply, for example, to the LTM scenario.

In some cases, the UE may need to send, in a single report instance, a report for the serving cell and one or more candidate cells that includes intra-frequency and/or inter-frequency measurements. In some cases, a reporting configuration is to be included in the configuration of the serving cell, and a resource configuration may be included, for example, in the configuration of the serving cell, the configuration of the candidate cell, or may be external to the configuration of the serving cell and the configuration of the candidate cell. In some cases, the UE may not be able to determine which reporting configuration is to be used. For example, the UE may not be able to determine which reporting configuration should be used to satisfy a requirement that the UE is to send, in the single report instance, the report for the serving cell and the one or more candidate cells that includes intra-frequency and/or inter-frequency measurements. This may result in the measurements for the candidate cell(s) not being properly reported to the serving cell, which may lead to disruptions in handover procedures, among other examples.

Techniques and apparatuses are described herein for a report configuration for a serving cell and a candidate cell. In some aspects, the UE may receive, from a serving cell, an updated serving cell configuration that includes a report configuration associated with reporting measurements for an LTM candidate cell. The UE may transmit, to the serving cell via a lower layer transmission, a measurement report that is based at least in part on the report configuration and that includes a measurement for the LTM candidate cell. Thus, the UE may accurately report the measurements for the serving cell and the one or more candidate cells in the single report instance. Additional details are described herein.

As indicated above, FIG. 6 is provided as an example. Other examples may differ from what is described with regard to FIG. 6.

FIG. 7 is a diagram illustrating an example 700 of a report configuration for a serving cell and a candidate cell, in accordance with the present disclosure. The UE 120 may communicate with a serving cell 705, for example, to report measurement information associated with the serving cell 705 and/or an LTM candidate cell 710. In some aspects, the serving cell 705 may be associated with a first DU 330 and the LTM candidate cell 710 may be associated with a second DU 330. In some other aspects, the serving cell 705 and the LTM candidate cell may be associated with the same DU 330. In some aspects, the network node may receive the report configuration from a CU 310.

As shown by reference number 715, the serving cell 705 may transmit, and the UE 120 may receive, an updated serving cell configuration that includes an updated report configuration associated with reporting measurements for an LTM candidate cell. Although not illustrated, it is understood that prior to the transmission of the updated serving cell configuration, the serving cell transmitted a previous serving cell configuration that includes a previous report configuration. Communications and measurement reporting prior to reference number 715 were performed in accordance with the previous serving cell configuration and the previous report configuration. As such, the updated serving cell configuration corresponds to an update of the previous serving cell configuration and similarly the updated serving cell configuration corresponds to an update of the previous report configuration. In some aspects, the difference between the updated serving cell configuration and the previous serving cell configuration is the updated report configuration, while in other aspects, other aspects of the serving cell configuration are also updated.

As shown by reference number 720, the UE 120 may transmit, and the serving cell 705 may receive, a measurement report that is based at least in part on the report configuration and that includes a measurement for the LTM candidate cell. The measurement report may be transmitted by the UE 120 using a lower layer transmission, such as an L1 transmission, an L2 transmission, or a Layer 3 (L3) transmission.

In some aspects, a CSI report configuration of the LTM candidate cell 710 is to be part of a serving cell configuration (e.g., ServingCellConfig) of the serving cell 705. At least one serving cell configuration of a current serving cell group is to include a report configuration for each LTM candidate cell 710 (to be measured).

In some aspects, the measurement report may be a measurement report associated with the serving cell 705 and/or the LTM candidate cell 710. For example, the measurement report may be for the serving cell 705 only, the LTM candidate cell 710 only, or for both the serving cell 705 and the LTM candidate cell 710.

In a first option, one report configuration may exclusively point to (e.g., indicate) a CSI resource configuration associated with CSI resources of the LTM candidate cell 710.

In a second example, one report configuration may point to a CSI resource configuration associated with a combination of CSI resources of the serving cell 705 and the LTM candidate cell 710.

In a third example, one report configuration may point to multiple CSI resource configurations, where one CSI resource configuration is associated with CSI resources of the serving cell 705, and another CSI resource configuration is associated with the CSI resources of the LTM candidate cell 710.

In some aspects, the first option may allow for separate CSI reporting of the serving cell 705 and the LTM candidate cell(s) 710. In some aspects, the second example and the third example may allow for combined reporting of the serving cell 705 and the LTM candidate cell(s) 710.

In some aspects, the first option may be used for SSB-based reporting, CSI-RS-based reporting, or a combination of SSB-based reporting and CSI-RS-based reporting. In some aspects, the second option and the third option may allow for SSB-based reporting for the serving cell 705 and/or the LTM candidate cell(s) 710, CSI-RS-based reporting for the serving cell 705 and/or the LTM candidate cell(s) 710, or a combination of SSB-based reporting and CSI-RS-based reporting for the serving cell 705 and/or the LTM candidate cell(s) 710.

An example solution for a configuration of SSB-based reporting is shown below:

| • | CSI-ReportConfig ::= SEQUENCE { | |
|---|---|---|
| | ∘ | reportConfigId CSI-ReportConfigId, |
| | ∘ | carrier ServCellIndex OPTIONAL, -- Need S |
| | ∘ | resourcesForChannelMeasurement CSI-ResourceConfigId, |
| | ∘ | ... |
| | } | |
| • | CSI-ResourceConfig ::= SEQUENCE { | |
| | ∘ | csi-ResourceConfigId CSI-ResourceConfigId, |
| | ∘ | csi-RS-ResourceSetList CHOICE { |

| | |
|---|---|
| ▪ | nzp-CSI-RS-SSB SEQUENCE { |

| | |
|---|---|
| • | nzp-CSI-RS-ResourceSetList SEQUENCE (SIZE |
| | (1..maxNrofNZP-CSI-RS-ResourceSetsPerConfig)) OF |
| | NZP-CSI-RS-ResourceSetId OPTIONAL, -- Need R |
| • | csi-SSB-ResourceSetList SEQUENCE (SIZE |
| | (1..maxNrofCSI-SSB-ResourceSetsPerConfig)) OF CSI- |
| | SSB-ResourceSetId OPTIONAL -- Need R |

| | |
|---|---|
| ▪ | }, |

| | |
|---|---|
| ∘ | ... |

| | |
|---|---|
| • | }, |
| • | bwp-Id BWP-Id, |
| • | ... |

}

| • | CSI-SSB-ResourceSet ::= SEQUENCE { | |
|---|---|---|
| | ∘ | csi-SSB-ResourceSetId CSI-SSB-ResourceSetId, |
| | ∘ | csi-SSB-ResourceList SEQUENCE (SIZE(1..maxNrofCSI-SSB- |
| | | ResourcePerSet)) OF SSB-Index, |
| | ∘ | ..., |
| | ∘ | [[ |
| | ∘ | servingAdditionalPCIList-r17 SEQUENCE (SIZE(1..maxNrofCSI-SSB- |
| | | ResourcePerSet)) OF ServingAdditionalPCIIndex-r17 OPTIONAL -- |
| | | Need R |
| | ∘ | ]] |

}

The CSI-ReportConfig includes resourcesForChannelMeasurement for serving cell and separate resourcesForChannelMeasurement for LTM or an LTM candidate with indication of the cell, potentially with indication of location of this configuration. This may use a separate CSI-ReportConfig with a pointer to a CSI-ReportConfig of a serving cell.

CSI-ResourceConfig includes csi-SSB-ResourceSetList for serving cell and another csi-SSB-ResourceSetList for LTM or an LTM candidate with corresponding indication of the cell.

In csi-SSB-ResourceSetList, each CSI-SSB-ResourceSet may correspond to a serving cell or an LTM (or LTM candidate) cell with corresponding indication of the cell.

A CSI-SSB-ResourceSet may include one csi-SSB-ResourceList for the serving cell and another csi-SSB-ResourceList for an LTM (or LTM candidate) cell with corresponding indication of the cell (potentially with corresponding AdditionalPCIList).

In csi-SSB-ResourceList, each SSB-index may correspond to a serving cell, additional PCI, or LTM cell with corresponding indication of the cell.

In some aspects, SMTC and frequency information may already be provided, or a pointer may be included, in the serving cell configuration of the LTM candidate cell 710. The UE 120 can early-decode the configuration of the LTM cell to obtain this information. This may be performed if the CSI-ResourceConfig for a LTM candidate cell 710 is included in the serving cell configuration of that cell. Alternatively, a separate SMTC and/or frequency information can be provided outside of the serving cell configuration of the LTM candidate cell 710 (e.g., inside or outside of a serving cell configuration of the serving cell 705). In some aspects, an indication of the LTM candidate cell 710 in the examples above may provide a pointer to the SMTC and/or frequency information.

An example solution for a configuration of CSI-RS-based reporting is shown below:

| • | CSI-ReportConfig ::= SEQUENCE { | |
|---|---|---|
| | ∘ | reportConfigId CSI-ReportConfigId, |
| | ∘ | carrier ServCellIndex OPTIONAL, -- Need S |
| | ∘ | resourcesForChannelMeasurement CSI-ResourceConfigId, |
| | ∘ | ... |
| | } | |
| • | CSI-ResourceConfig ::= SEQUENCE { | |
| | ∘ | csi-ResourceConfigId CSI-ResourceConfigId, |
| | ∘ | csi-RS-ResourceSetList CHOICE { |

| | |
|---|---|
| ▪ | nzp-CSI-RS-SSB SEQUENCE { |

| | |
|---|---|
| • | nzp-CSI-RS-ResourceSetList SEQUENCE (SIZE |
| | (1..maxNrofNZP-CSI-RS-ResourceSetsPerConfig)) OF |
| | NZP-CSI-RS-ResourceSetId OPTIONAL, -- Need R |
| • | csi-SSB-ResourceSetList SEQUENCE (SIZE |
| | (1..maxNrofCSI-SSB-ResourceSetsPerConfig)) OF CSI- |
| | SSB-ResourceSetId OPTIONAL -- Need R |

| | |
|---|---|
| ▪ | }, |

| | ∘ | ... |
|---|---|---|
| | ∘ | }, |
| | ∘ | bwp-Id BWP-Id, |
| | ∘ | ... |
| | } | |
| • | NZP-CSI-RS-ResourceSet ::= SEQUENCE { | |
| | ∘ | nzp-CSI-ResourceSetId NZP-CSI-RS-ResourceSetId, |
| | ∘ | nzp-CSI-RS-Resources SEQUENCE (SIZE (1..maxNrofNZP-CSI-RS- |
| | | ResourcesPerSet)) OF NZP-CSI-RS-ResourceId, |
| | ∘ | ... |

}

A CSI-ReportConfig includes resourcesForChannelMeasurement for serving cell and separate resourcesForChannelMeasurement for LTM or an LTM candidate with indication of the cell, potentially with indication of location of CSI-Resource config for the latter. This may use a separate CSI-ReportConfig with a pointer to a CSI-ReportConfig of a serving cell.

CSI-ResourceConfig includes a non-zero power (NZP) CSI-RS resource set list (nzp-CSI-RS-ResourceSetList) for serving cell and another nzp-CSI-RS-ResourceSetList for an LTM (or LTM candidate) cell with corresponding indication of the cell.

In nzp-CSI-RS-ResourceSetList, each NZP-CSI-RS-ResourceSet may correspond to a serving cell or an LTM (or LTM candidate) cell with corresponding indication of the cell.

An NZP-CSI-RS-ResourceSet may include one nzp-CSI-RS-Resources for the serving cell and another nzp-CSI-RS-Resources for an LTM (or LTM candidate) cell with corresponding indication of the cell.

In nzp-CSI-RS-Resources, each NZP-CSI-RS-ResourceId may correspond to a serving cell or LTM cell with corresponding indication of the cell.

In some aspects, the CSI-ReportConfigs associated with an LTM cell may be provided as part of the configuration of multiple serving cells to enable reporting on multiple serving cells. Alternatively, reporting may be restricted to the serving PCell. In some aspects, a report configuration may be associated with resources corresponding to one or more LTM cells. The UE may be dynamically queried to submit report(s) for a subset of the resources corresponding to a particular report configuration to allow dynamic measurement of LTM cells to minimize overhead.

In some aspects, the UE is configured with a plurality of LTM candidate cells that includes at least the LTM candidate cell and another LTM candidate cell. In some aspects, the report configuration is associated with one or more measurement resources for the serving cell and one of the LTM candidate cell or the other LTM candidate cell. In some aspects, the report configuration is associated with one or more measurement resources for the serving cell, the LTM candidate cell, and the other LTM candidate cell. In some aspects, the report configuration includes a first report configuration associated with one or more measurement resources for the serving cell and a second report configuration associated with one or more measurement resources for one of the LTM candidate cell or the other LTM candidate cell. In some aspects, the report configuration includes a first report configuration associated with one or more measurement resources for the serving cell, a second report configuration associated with one or more measurement resources for the LTM candidate cell, and a third report configuration associated with one or more resources for the other LTM candidate cell.

In some aspects, the UE is configured with a plurality of serving cells that includes at least the serving cell and another serving cell. In some aspects, the LTM candidate cell is configured to be reported on the serving cell and another LTM candidate cell is configured to be reported on the other serving cell. In some aspects, the LTM candidate cell and another LTM candidate cell are configured to be reported on the serving cell, wherein a reporting on the serving cell uses a first report configuration and a reporting on the other serving cell uses a second report configuration.

In some aspects, the first report configuration associated with the serving cell may be the same as previous the report configuration associated with the serving cell, or may also be updated, and the second report configuration may be new compared to the previous report configuration before the updated serving cell configuration. In some aspects, the third report configuration may be new compared to the previous report configuration.

In some aspects, the UE may receive an LTM candidate cell configuration that includes a report configuration associated with reporting measurements for the serving cell. The UE may apply the report configuration associated with reporting measurements for the serving cell after executing an LTM operation and establishing a connection to the LTM candidate cell. In some aspects, the report configuration associated with reporting measurements for the serving cell includes a report configuration associated with reporting measurements for another LTM candidate cell. In some aspects, the UE may apply the report configuration associated with reporting measurements for the other LTM candidate cell based at least in part on executing an LTM operation and establishing a connection to the LTM candidate cell.

As indicated above, FIG. 7 is provided as an example. Other examples may differ from what is described with regard to FIG. 7.

FIG. 8 is a diagram illustrating an example process 800 performed, for example, by a UE, in accordance with the present disclosure. Example process 800 is an example where the UE (e.g., UE 120) performs operations associated with a report configuration for a serving cell and a candidate cell.

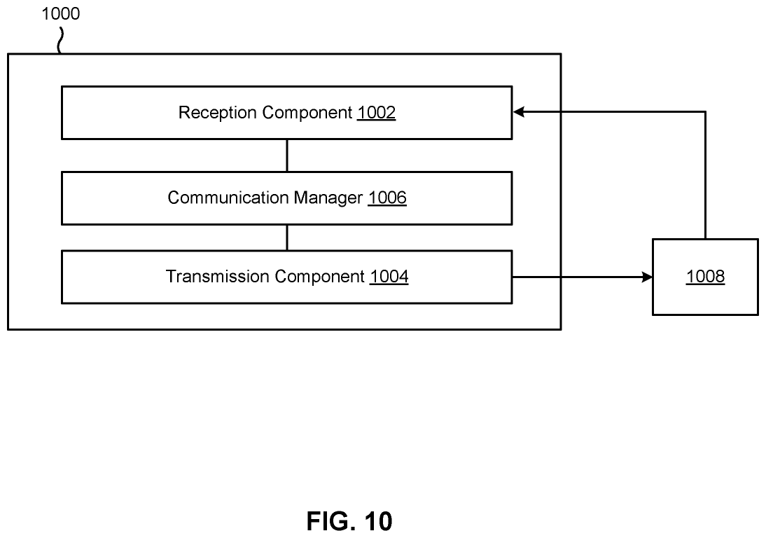

As shown in FIG. 8, in some aspects, process 800 may include receiving, from a serving cell, an updated serving cell configuration that includes a report configuration associated with reporting measurements for a layer 1 or layer 2 triggered mobility (LTM) candidate cell (block 810). For example, the UE (e.g., using communication manager 140 and/or reception component 1002, depicted in FIG. 10) may receive, from a serving cell, an updated serving cell configuration that includes a report configuration associated with reporting measurements for a layer 1 or layer 2 triggered mobility (LTM) candidate cell, as described above, for example, with reference to FIG. 7.

As further shown in FIG. 8, in some aspects, process 800 may include transmitting, to the serving cell via a lower layer transmission, a measurement report that is based at least in part on the report configuration and that includes a measurement for the LTM candidate cell (block 820). For example, the UE (e.g., using communication manager 140 and/or transmission component 1004, depicted in FIG. 10) may transmit, to the serving cell via a lower layer transmission, a measurement report that is based at least in part on the report configuration and that includes a measurement for the LTM candidate cell, as described above, for example, with reference to FIG. 7.

Process 800 may include additional aspects, such as any single aspect or any combination of aspects described below and/or in connection with one or more other processes described elsewhere herein.

In a first aspect, the report configuration indicates a channel state information (CSI) resource configuration that is associated with one or more CSI resources of the LTM candidate cell.

In a second aspect, alone or in combination with the first aspect, transmitting the measurement report comprises transmitting separate CSI measurement reports for the serving cell and the LTM candidate cell.

In a third aspect, alone or in combination with one or more of the first and second aspects, transmitting the measurement report comprises transmitting a measurement report that includes a synchronization signal block measurement.

In a fourth aspect, alone or in combination with one or more of the first through third aspects, transmitting the measurement report comprises transmitting a measurement report that includes a channel state information reference signal measurement.

In a fifth aspect, alone or in combination with one or more of the first through fourth aspects, transmitting the measurement report comprises transmitting a measurement report that includes a synchronization signal block measurement and a channel state information reference signal measurement.

In a sixth aspect, alone or in combination with one or more of the first through fifth aspects, the report configuration indicates a channel state information (CSI) resource configuration that is associated with one or more CSI resources of the serving cell and one or more CSI resources of the LTM candidate cell.

In a seventh aspect, alone or in combination with one or more of the first through sixth aspects, transmitting the measurement report comprises transmitting a combined CSI measurement report for the serving cell and the LTM candidate cell.

In an eighth aspect, alone or in combination with one or more of the first through seventh aspects, transmitting the measurement report comprises transmitting a synchronization-signal-block-based measurement report for at least one of the serving cell or the LTM candidate cell.

In a ninth aspect, alone or in combination with one or more of the first through eighth aspects, transmitting the measurement report comprises transmitting a CSI-reference-signal-based measurement report for at least one of the serving cell or the LTM candidate cell.

In a tenth aspect, alone or in combination with one or more of the first through ninth aspects, transmitting the measurement report comprises transmitting a synchronization-signal-block-based measurement report and a CSI-reference-signal-based measurement report for at least one of the serving cell or the LTM candidate cell.

In an eleventh aspect, alone or in combination with one or more of the first through tenth aspects, transmitting the measurement report comprises transmitting at least one of a synchronization-signal-block-based measurement report or a CSI-reference-signal-based measurement report for the serving cell and at least one of the synchronization-signal-block-based measurement report or the CSI-reference-signal-based measurement report for the LTM candidate cell.

In a twelfth aspect, alone or in combination with one or more of the first through eleventh aspects, the report configuration indicates a first channel state information (CSI) resource configuration that is associated with one or more CSI resources of the serving cell and a second CSI resource configuration that is associated with one or more CSI resources of the LTM candidate cell.

In a thirteenth aspect, alone or in combination with one or more of the first through twelfth aspects, transmitting the measurement report comprises transmitting a combined CSI measurement report for the serving cell and the LTM candidate cell.

In a fourteenth aspect, alone or in combination with one or more of the first through thirteenth aspects, transmitting the measurement report comprises transmitting a synchronization-signal-block-based measurement report for at least one of the serving cell or the LTM candidate cell.

In a fifteenth aspect, alone or in combination with one or more of the first through fourteenth aspects, transmitting the measurement report comprises transmitting a CSI-reference-signal-based measurement report for at least one of the serving cell or the LTM candidate cell.

In a sixteenth aspect, alone or in combination with one or more of the first through fifteenth aspects, transmitting the measurement report comprises transmitting a synchronization-signal-block-based measurement report and a CSI-reference-signal-based measurement report for at least one of the serving cell or the LTM candidate cell.

In a seventeenth aspect, alone or in combination with one or more of the first through sixteenth aspects, transmitting the measurement report comprises transmitting at least one of a synchronization-signal-block-based measurement report or a CSI-reference-signal-based measurement report for the serving cell and at least one of the synchronization-signal-block-based measurement report or the CSI-reference-signal-based measurement report for the LTM candidate cell.

In an eighteenth aspect, alone or in combination with one or more of the first through seventeenth aspects, the UE is configured with a plurality of LTM candidate cells that includes at least the LTM candidate cell and another LTM candidate cell.

In a nineteenth aspect, alone or in combination with one or more of the first through eighteenth aspects, the report configuration is associated with one or more measurement resources for the serving cell and one of the LTM candidate cell or the other LTM candidate cell.

In a twentieth aspect, alone or in combination with one or more of the first through nineteenth aspects, the report configuration is associated with one or more measurement resources for the serving cell, the LTM candidate cell, and the other LTM candidate cell.

In a twenty-first aspect, alone or in combination with one or more of the first through twentieth aspects, the report configuration includes a first report configuration associated with one or more measurement resources for the serving cell and a second report configuration associated with one or more measurement resources for one of the LTM candidate cell or the other LTM candidate cell.

In a twenty-second aspect, alone or in combination with one or more of the first through twenty-first aspects, the report configuration includes a first report configuration associated with one or more measurement resources for the serving cell, a second report configuration associated with one or more measurement resources for the LTM candidate cell, and a third report configuration associated with one or more resources for the other LTM candidate cell.

In a twenty-third aspect, alone or in combination with one or more of the first through twenty-second aspects, the UE is configured with a plurality of serving cells that includes at least the serving cell and another serving cell.

In a twenty-fourth aspect, alone or in combination with one or more of the first through twenty-third aspects, the LTM candidate cell is configured to be reported on the serving cell and another LTM candidate cell is configured to be reported on the other serving cell.

In a twenty-fifth aspect, alone or in combination with one or more of the first through twenty-fourth aspects, the LTM candidate cell and another LTM candidate cell are configured to be reported on the serving cell, wherein a reporting on the serving cell uses a first report configuration and a reporting on the other serving cell uses a second report configuration.

In a twenty-sixth aspect, alone or in combination with one or more of the first through twenty-fifth aspects, process 800 includes receiving an LTM candidate cell configuration that includes a report configuration associated with reporting measurements for the serving cell.

In a twenty-seventh aspect, alone or in combination with one or more of the first through twenty-sixth aspects, process 800 includes applying the report configuration associated with reporting measurements for the serving cell after executing an LTM operation and establishing a connection to the LTM candidate cell.

In a twenty-eighth aspect, alone or in combination with one or more of the first through twenty-seventh aspects, the report configuration associated with reporting measurements for the serving cell includes a report configuration associated with reporting measurements for another LTM candidate cell.

In a twenty-ninth aspect, alone or in combination with one or more of the first through twenty-eighth aspects, process 800 includes applying the report configuration associated with reporting measurements for the other LTM candidate cell based at least in part on executing an LTM operation and establishing a connection to the LTM candidate cell.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a serving cell, in accordance with the present disclosure. Example process 900 is an example where the serving cell (e.g., serving cell 705) performs operations associated with report a configuration for a serving cell and a candidate cell.

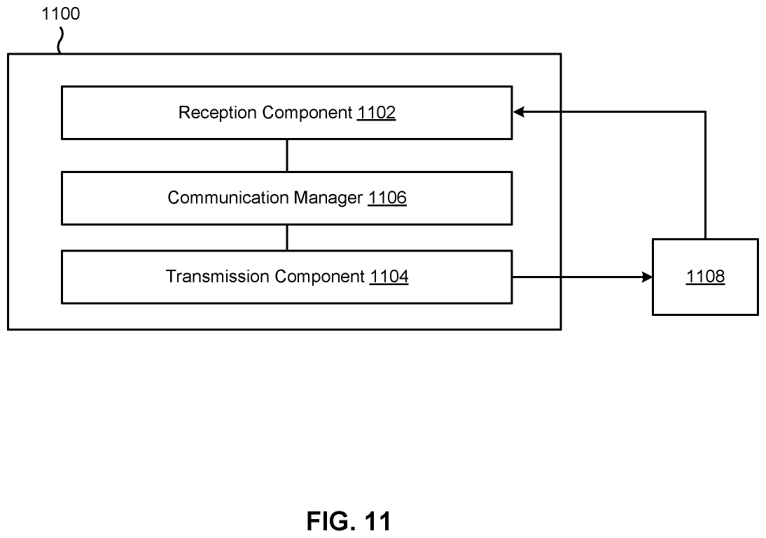

As shown in FIG. 9, in some aspects, process 900 may include transmitting, to a user equipment (UE), an updated serving cell configuration that includes a report configuration associated with reporting measurements for a layer 1 or layer 2 triggered mobility (LTM) candidate cell (block 910). For example, the serving cell (e.g., using communication manager 1106 and/or transmission component 1104, depicted in FIG. 11) may transmit, to a user equipment (UE), an updated serving cell configuration that includes a report configuration associated with reporting measurements for a layer 1 or layer 2 triggered mobility (LTM) candidate cell, as described above, for example, with reference to FIG. 7.

As further shown in FIG. 9, in some aspects, process 900 may include receiving, from the UE via a lower layer transmission, a measurement report that is based at least in part on the report configuration and that includes a measurement for the LTM candidate cell (block 920). For example, the serving cell (e.g., using communication manager 1106 and/or reception component 1102, depicted in FIG. 11) may receive, from the UE via a lower layer transmission, a measurement report that is based at least in part on the report configuration and that includes a measurement for the LTM candidate cell, as described above, for example, with reference to FIG. 7.

Process 900 may include additional aspects, such as any single aspect or any combination of aspects described below and/or in connection with one or more other processes described elsewhere herein.

In a first aspect, the serving cell is associated with a first distributed network node and the LTM candidate cell is associated with a second distributed network node.

In a second aspect, alone or in combination with the first aspect, the serving cell and the LTM candidate cell are associated with a same distributed network node.

In a third aspect, alone or in combination with one or more of the first and second aspects, process 900 includes receiving the report configuration from a central network node.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 140 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIG. 7. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The reception component 1002 may receive, from a serving cell, an updated serving cell configuration that includes a report configuration associated with reporting measurements for an LTM candidate cell. The transmission component 1004 may transmit, to the serving cell via a lower layer transmission, a measurement report that is based at least in part on the report configuration and that includes a measurement for the LTM candidate cell.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a serving cell, or a serving cell may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIG. 7. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the serving cell described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the serving cell described in connection with FIG. 2.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, a modem, a modulator, a transmit MIMO processor, a transmit processor, a controller/processor, a memory, or a combination thereof, of the serving cell described in connection with FIG. 2. In some aspects, the transmission component 1104 may be co-located with the reception component 1102 in a transceiver.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The transmission component 1104 may transmit, to a UE, an updated serving cell configuration that includes a report configuration associated with reporting measurements for an LTM candidate cell. The reception component 1102 may receive, from the UE via a lower layer transmission, a measurement report that is based at least in part on the report configuration and that includes a measurement for the LTM candidate cell. The reception component 1102 may receive the report configuration from a central network node.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE), comprising: receiving, from a serving cell, an updated serving cell configuration that includes a report configuration associated with reporting measurements for a layer 1 or layer 2 triggered mobility (LTM) candidate cell; and transmitting, to the serving cell via a lower layer transmission, a measurement report that is based at least in part on the report configuration and that includes a measurement for the LTM candidate cell.

Aspect 2: The method of Aspect 1, wherein the report configuration indicates a channel state information (CSI) resource configuration that is associated with one or more CSI resources of the LTM candidate cell.

Aspect 3: The method of Aspect 2, wherein transmitting the measurement report comprises transmitting separate CSI measurement reports for the serving cell and the LTM candidate cell.

Aspect 4: The method of Aspect 2, wherein transmitting the measurement report comprises transmitting a measurement report that includes a synchronization signal block measurement.

Aspect 5: The method of Aspect 2, wherein transmitting the measurement report comprises transmitting a measurement report that includes a channel state information reference signal measurement.

Aspect 6: The method of Aspect 2, wherein transmitting the measurement report comprises transmitting a measurement report that includes a synchronization signal block measurement and a channel state information reference signal measurement.

Aspect 7: The method of any of Aspects 1-6, wherein the report configuration indicates a channel state information (CSI) resource configuration that is associated with one or more CSI resources of the serving cell and one or more CSI resources of the LTM candidate cell.

Aspect 8: The method of Aspect 7, wherein transmitting the measurement report comprises transmitting a combined CSI measurement report for the serving cell and the LTM candidate cell.

Aspect 9: The method of Aspect 7, wherein transmitting the measurement report comprises transmitting a synchronization-signal-block-based measurement report for at least one of the serving cell or the LTM candidate cell.

Aspect 10: The method of Aspect 7, wherein transmitting the measurement report comprises transmitting a CSI-reference-signal-based measurement report for at least one of the serving cell or the LTM candidate cell.

Aspect 11: The method of Aspect 7, wherein transmitting the measurement report comprises transmitting a synchronization-signal-block-based measurement report and a CSI-reference-signal-based measurement report for at least one of the serving cell or the LTM candidate cell.

Aspect 12: The method of Aspect 7, wherein transmitting the measurement report comprises transmitting at least one of a synchronization-signal-block-based measurement report or a CSI-reference-signal-based measurement report for the serving cell and at least one of the synchronization-signal-block-based measurement report or the CSI-reference-signal-based measurement report for the LTM candidate cell.

Aspect 13: The method of any of Aspects 1-12, wherein the report configuration indicates a first channel state information (CSI) resource configuration that is associated with one or more CSI resources of the serving cell and a second CSI resource configuration that is associated with one or more CSI resources of the LTM candidate cell.

Aspect 14: The method of Aspect 13, wherein transmitting the measurement report comprises transmitting a combined CSI measurement report for the serving cell and the LTM candidate cell.

Aspect 15: The method of Aspect 13, wherein transmitting the measurement report comprises transmitting a synchronization-signal-block-based measurement report for at least one of the serving cell or the LTM candidate cell.

Aspect 16: The method of Aspect 13, wherein transmitting the measurement report comprises transmitting a CSI-reference-signal-based measurement report for at least one of the serving cell or the LTM candidate cell.

Aspect 17: The method of Aspect 13, wherein transmitting the measurement report comprises transmitting a synchronization-signal-block-based measurement report and a CSI-reference-signal-based measurement report for at least one of the serving cell or the LTM candidate cell.

Aspect 18: The method of Aspect 13, wherein transmitting the measurement report comprises transmitting at least one of a synchronization-signal-block-based measurement report or a CSI-reference-signal-based measurement report for the serving cell and at least one of the synchronization-signal-block-based measurement report or the CSI-reference-signal-based measurement report for the LTM candidate cell.

Aspect 19: The method of any of Aspects 1-18, wherein the report configuration is associated with reporting measurements for a plurality of LTM candidate cells that includes at least the LTM candidate cell and another LTM candidate cell.

Aspect 20: The method of Aspect 19, wherein the report configuration is associated with one or more measurement resources for the serving cell and one of the LTM candidate cell or the other LTM candidate cell.

Aspect 21: The method of Aspect 19, wherein the report configuration is associated with one or more measurement resources for the serving cell, the LTM candidate cell, and the other LTM candidate cell.

Aspect 22: The method of Aspect 19, wherein the report configuration includes a first report configuration associated with one or more measurement resources for the serving cell and a second report configuration associated with one or more measurement resources for one of the LTM candidate cell or the other LTM candidate cell.

Aspect 23: The method of Aspect 19, wherein the report configuration includes a first report configuration associated with one or more measurement resources for the serving cell, a second report configuration associated with one or more measurement resources for the LTM candidate cell, and a third report configuration associated with one or more resources for the other LTM candidate cell.

Aspect 24: The method of any of Aspects 1-23, wherein the UE is configured with a plurality of serving cells that includes at least the serving cell and another serving cell.

Aspect 25: The method of Aspect 24, wherein the LTM candidate cell is configured to be reported on the serving cell and another LTM candidate cell is configured to be reported on the other serving cell.

Aspect 26: The method of Aspect 24, wherein the LTM candidate cell and another LTM candidate cell are configured to be reported on the serving cell, wherein a reporting on the serving cell uses a first report configuration and a reporting on the other serving cell uses a second report configuration.

Aspect 27: The method of any of Aspects 1-26, further comprising receiving an LTM candidate cell configuration that includes a report configuration associated with reporting measurements for the serving cell.

Aspect 28: The method of Aspect 27, further comprising applying the report configuration associated with reporting measurements for the serving cell after executing an LTM operation and establishing a connection to the LTM candidate cell.

Aspect 29: The method of Aspect 27, wherein the report configuration associated with reporting measurements for the serving cell includes a report configuration associated with reporting measurements for another LTM candidate cell.

Aspect 30: The method of Aspect 29, further comprising applying the report configuration associated with reporting measurements for the other LTM candidate cell based at least in part on executing an LTM operation and establishing a connection to the LTM candidate cell.

Aspect 31: A method of wireless communication performed by a serving cell, comprising: transmitting, to a user equipment (UE), an updated serving cell configuration that includes a report configuration associated with reporting measurements for a layer 1 or layer 2 triggered mobility (LTM) candidate cell; and receiving, from the UE via a lower layer transmission, a measurement report that is based at least in part on the report configuration and that includes a measurement for the LTM candidate cell.

Aspect 32: The method of Aspect 31, wherein the serving cell is associated with a first distributed network node and the LTM candidate cell is associated with a second distributed network node.

Aspect 33: The method of any of Aspects 31-32, wherein the serving cell and the LTM candidate cell are associated with a same distributed network node.

Aspect 34: The method of any of Aspects 31-33, further comprising receiving the report configuration from a central network node.

Aspect 35: An apparatus for wireless communication at a device, comprising a processor; memory coupled with the processor; and instructions stored in the memory and executable by the processor to cause the apparatus to perform the method of one or more of Aspects 1-34.

Aspect 36: A device for wireless communication, comprising a memory and one or more processors coupled to the memory, the one or more processors configured to perform the method of one or more of Aspects 1-34.

Aspect 37: An apparatus for wireless communication, comprising at least one means for performing the method of one or more of Aspects 1-34.

Aspect 38: A non-transitory computer-readable medium storing code for wireless communication, the code comprising instructions executable by a processor to perform the method of one or more of Aspects 1-34.

Aspect 39: A non-transitory computer-readable medium storing a set of instructions for wireless communication, the set of instructions comprising one or more instructions that, when executed by one or more processors of a device, cause the device to perform the method of one or more of Aspects 1-34.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
one or more memories; and
one or more processors, coupled to the one or more memories, configured to:
receive, from a serving cell, an updated serving cell configuration that includes an updated report configuration associated with reporting measurements for a layer 1 or layer 2 triggered mobility (LTM) candidate cell; and
transmit, to the serving cell via a lower layer transmission, a measurement report that is based at least in part on the updated report configuration and that includes a measurement for the LTM candidate cell.

2. The UE of claim 1, wherein the updated report configuration indicates a channel state information (CSI) resource configuration that is associated with one or more CSI resources of the LTM candidate cell.

3. The UE of claim 2, wherein the one or more processors, to transmit the measurement report, are configured to transmit separate CSI measurement reports for the serving cell and the LTM candidate cell.

4. The UE of claim 2, wherein the one or more processors, to transmit the measurement report, are configured to transmit the measurement report including at least one of a synchronization signal block measurement or a channel state information reference signal measurement.

5. The UE of claim 1, wherein the updated report configuration is associated with reporting measurements for a plurality of LTM candidate cells that includes at least the LTM candidate cell and an other LTM candidate cell.

6. The UE of claim 5, wherein the updated report configuration is associated with one or more measurement resources for the serving cell and one of the LTM candidate cell or the other LTM candidate cell.

7. The UE of claim 5, wherein the updated report configuration is associated with one or more measurement resources for the serving cell, the LTM candidate cell, and the other LTM candidate cell.

8. The UE of claim 5, wherein the updated report configuration includes a first report configuration associated with one or more measurement resources for the serving cell and a second report configuration associated with one or more measurement resources for one of the LTM candidate cell or the other LTM candidate cell.

9. The UE of claim 5, wherein the updated report configuration includes a first report configuration associated with one or more measurement resources for the serving cell, a second report configuration associated with one or more measurement resources for the LTM candidate cell, and a third report configuration associated with one or more resources for the other LTM candidate cell.

10. The UE of claim 1, wherein the one or more processors are further configured to receive an LTM candidate cell configuration that includes a report configuration associated with reporting measurements for the serving cell.

11. The UE of claim 10, wherein the one or more processors are further configured to apply the report configuration associated with reporting measurements for the serving cell after executing an LTM operation and establishing a connection to the LTM candidate cell.

12. The UE of claim 10, wherein the report configuration associated with reporting measurements for the serving cell includes a report configuration associated with reporting measurements for an other LTM candidate cell.

13. The UE of claim 12, wherein the one or more processors are further configured to apply the report configuration associated with reporting measurements for the other LTM candidate cell based at least in part on executing an LTM operation and establishing a connection to the LTM candidate cell.

14. A serving cell for wireless communication, comprising:
one or more memories; and
one or more processors, coupled to the one or more memories, configured to:
transmit, to a user equipment (UE), an updated serving cell configuration that includes an updated report configuration associated with reporting measurements for a layer 1 or layer 2 triggered mobility (LTM) candidate cell; and
receive, from the UE via a lower layer transmission, a measurement report that is based at least in part on the updated report configuration and that includes a measurement for the LTM candidate cell.

15. The serving cell of claim 14, wherein the serving cell is associated with a first distributed network node and the LTM candidate cell is associated with a second distributed network node.

16. The serving cell of claim 14, wherein the serving cell and the LTM candidate cell are associated with a same distributed network node.

17. The serving cell of claim 14, wherein the one or more processors are further configured to receive the updated report configuration from a central network node.

18. A method of wireless communication performed by a user equipment (UE), comprising:
receiving, from a serving cell, an updated serving cell configuration that includes an updated report configuration associated with reporting measurements for a layer 1 or layer 2 triggered mobility (LTM) candidate cell; and
transmitting, to the serving cell via a lower layer transmission, a measurement report that is based at least in part on the updated report configuration and that includes a measurement for the LTM candidate cell.

19. The method of claim 18, wherein the updated report configuration indicates a channel state information (CSI) resource configuration that is associated with one or more CSI resources of the LTM candidate cell.

20. The method of claim 19, wherein transmitting the measurement report comprises transmitting separate CSI measurement reports for the serving cell and the LTM candidate cell.

21. The method of claim 18, wherein the updated report configuration is associated with reporting measurements for a plurality of LTM candidate cells that includes at least the LTM candidate cell and an other LTM candidate cell.

22. The method of claim 21, wherein the updated report configuration is associated with one or more measurement resources for the serving cell and one of the LTM candidate cell or the other LTM candidate cell.

23. The method of claim 21, wherein the updated report configuration is associated with one or more measurement resources for the serving cell, the LTM candidate cell, and the other LTM candidate cell.

24. The method of claim 21, wherein the updated report configuration includes a first report configuration associated with one or more measurement resources for the serving cell and a second report configuration associated with one or more measurement resources for one of the LTM candidate cell or the other LTM candidate cell.

25. The method of claim 21, wherein the updated report configuration includes a first report configuration associated with one or more measurement resources for the serving cell, a second report configuration associated with one or more measurement resources for the LTM candidate cell, and a third report configuration associated with one or more resources for the other LTM candidate cell.

26. The method of claim 18, further comprising receiving an LTM candidate cell configuration that includes a report configuration associated with reporting measurements for the serving cell.

27. The method of claim 26, further comprising applying the report configuration associated with reporting measurements for the serving cell after executing an LTM operation and establishing a connection to the LTM candidate cell.

28. The method of claim 26, wherein the report configuration associated with reporting measurements for the serving cell includes a report configuration associated with reporting measurements for an other LTM candidate cell.

29. The method of claim 27, further comprising applying the report configuration associated with reporting measurements for the other LTM candidate cell based at least in part on executing an LTM operation and establishing a connection to the LTM candidate cell.

30. A method of wireless communication performed by a serving cell, comprising:
transmitting, to a user equipment (UE), an updated serving cell configuration that includes an updated report configuration associated with reporting measurements for a layer 1 or layer 2 triggered mobility (LTM) candidate cell; and
receiving, from the UE via a lower layer transmission, a measurement report that is based at least in part on the updated report configuration and that includes a measurement for the LTM candidate cell.
